(19) United States
(12) Patent Application Publication
(10) Pub. No.: US 2003/0073468 A1
(43) Pub. Date: Apr. 17, 2003

(54) Extension device for speedy connection of various hand free devices of cellular phones to service centers

(75) Inventor: Tonny Chen, Chang-Hua (TW)

Correspondence Address: DOUGHERTY & TROXELL, SUITE 1404, 5205 LEESBURG PIKE, FALLS CHURCH, VA, 22041, US

(73) Assignee: E-Lead Electronic Co., Ltd.

(21) Appl. No.: 09/978,036

(22) Filed: Oct. 17, 2001

(51) Int. Cl. H04M 1/00

(52) U.S. Cl. 455/569; 455/564

(57) ABSTRACT

An extension device adapted for speedy connection of various types of hand free devices for cellular phones to service centers is mainly made up of a control unit, a power supply processing unit, a press button unit, a data storage unit and a dialing unit. Alternatively, an infrared receiving unit in cooperation with an infrared transmitter can be added thereto. Thereby such an extension device enables all types of hand-free devices for cellular phones to be quickly connected to service centers in request for required services.

### BACKGROUND OF THE INVENTION

The present invention relates to an extension device adapted for speedy connection of various types of hand free devices of cellular phones to service centers. It mainly comprises a control unit, a power supply processing unit, a press button unit, a data storage unit and a dialing unit. Alternatively, an infrared receiving unit in cooperation with an infrared transmitter can be added thereto. Thereby such an extension device enables all types of hand-free devices for cellular phones to be quickly connected to service centers in request for required services.

In a knowledge explosion time, people are eager to acquire information not only from newspaper, magazines and other media but also from all sources available to them. Timely, personal and portable devices are needed to meet such a requirement. The answer is cellular phones in connection to all kinds of fee charging service centers to acquire instant information, such as road conditions, weathers, consumer's information, on-line service, driving navigation, SOS calls and etc.. However, the speedy connection to such service centers is a major concern to most users. Direct dialing of cellular phones is impossible for speedy connection in driving, and it is also dangerous and forbidden by laws in many countries. In emergent situations, only a few seconds are available to send off SOS signals or make a dial. How can a user do it? Common cellular phones can not meet such a need. Even hand free devices produced in many types are not all able to perform such a speedy connection. So, it is the main purpose of this invention to enable all types of hand free devices to make speedy connection to service centers, rendering instant connection to service centers possible.

### SUMMARY OF THE INVENTION

Therefore, the primary object of the present invention is to provide an extension device for speedy connection of various kinds of hand-free devices of cellular phones to service centers.

### BRIEF DESCRIPTION OF THE DRAWINGS

FIG. 1 is a diagram showing the operational connection of the present invention;

FIG. 2 is a block diagram showing the systematic structure of the present invention;

FIG. 3 is an operation flow chart of the present invention;

FIG. 4 is a block diagram of the systematic structure of the second embodiment of the present invention;

FIG. 5 is an operation flow chart of the second embodiment thereof;

FIG. 6 is a block diagram of the systematic structure of the third embodiment of the present invention;

FIG. 7 is an operation flow chart of the third embodiment thereof.

### DETAILED DESCRIPTION OF THE PREFERRED EMBODIMENTS

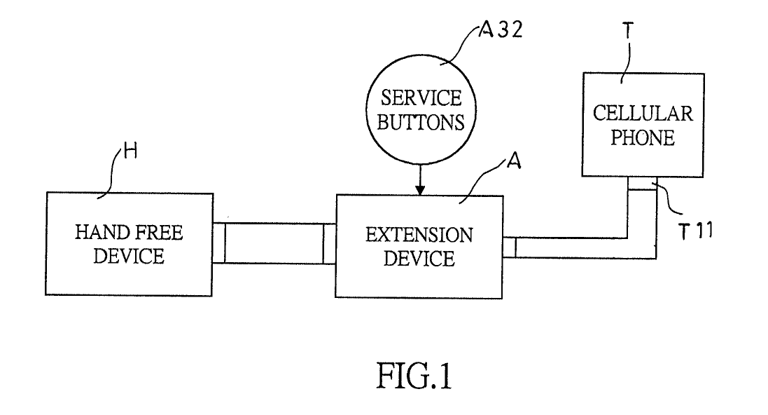

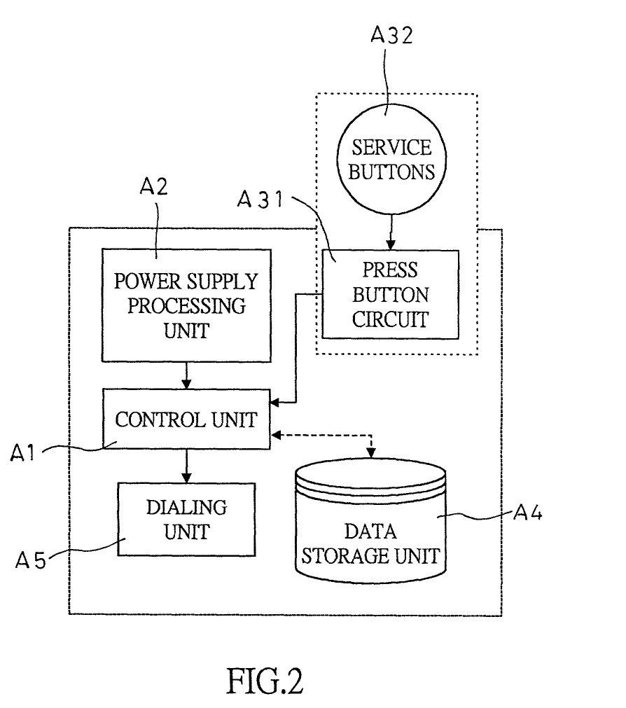

Referring to FIGS. 1, 2, the present invention is illustrated in details of its first practical embodiment and systematic block diagrams thereof. It mainly has an extension device A in connection to a cellular phone T at one end and to a hand free device H at the other end.

The extension device A is further comprised of:

a control unit A1 is mainly used to control the operations of individual units of the extension device A and is internally equipped with a control program;

a power supply processing unit A2 coupled to a power circuit of the hand free device H is used to supply electrical power to the extension device A;

a press button unit A3 includes a press button circuit A31 and at least a service button A32 or a set of press buttons that are respectively marked with a functional indication of service provided by the buttons; each one of the buttons corresponds to a phone number stored in the data storage unit;

a data storage unit A4 is a temporary memory unit for storage of phone numbers to be dialed;

a dialing unit A5 can be a DTMF or other dialing circuits for receiving and coding the phone numbers transmitted from the control unit A1 and delivering further to the cellular phone T for effecting automatic dialing purpose;

By way of the assembly of the above components, when a user intends to promote the function of the hand free device H and the cellular phone T in such a manner that dialing of the cellular phone T can be effected by actuation of the service buttons A32, the hand free device H of the cellular phone is coupled to one end of the extension device A and the other end of the extension device A is connected to the output/input terminal T1 of the cellular phone. Thereby, the functional extension of the hand free device as well as the cellular phone is accomplished.

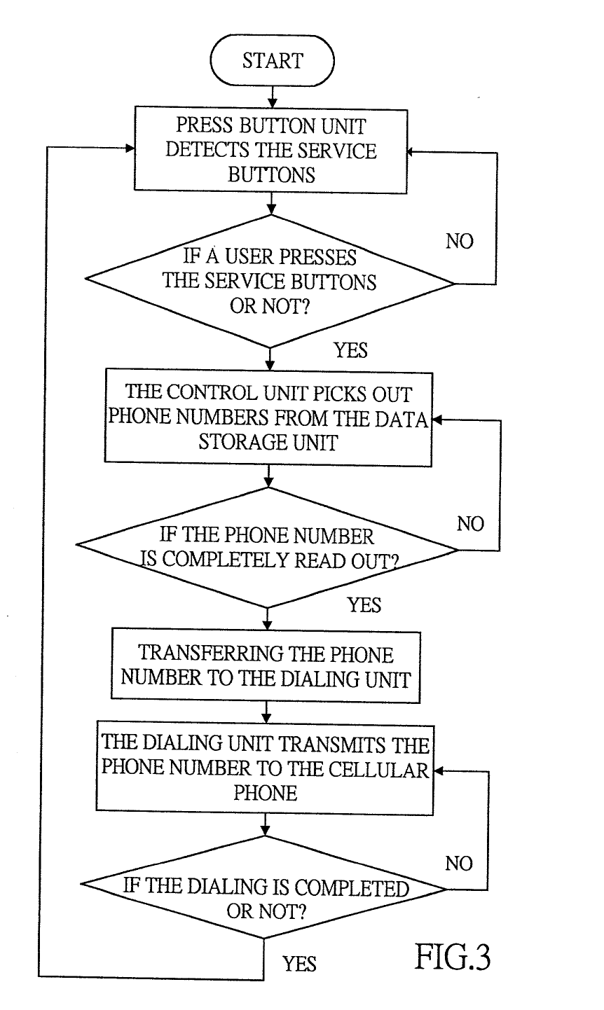

As shown in FIG. 3 is the flow chart of the operation of the present invention.

1. After the extension device A is in connection to the cellular phone T, the hand free device, the extension device A is set in a standby mode.

2. The press button circuit A31 of the press button unit A3 of the extension device A checks if a user presses the service button A32.

3. After the service button A32 is pressed by a user, the control unit A1 picks out one of preset phone numbers from the data storage unit A4. The numbers can be preset in production line or is set in advance by a user.

4. Check if the phone number has been read out, if not, step 3 is repeated; if completed, the control unit A1 will transmit the phone number to the dialing unit A5 and a dialing signal is sent via an output wire to the output/input terminal T1 of the cellular phone, rendering the cellular phone T in a to-be-dialed status in which a phone number is ready to be input.

5. The dialing unit A5 will control to deliver the phone number transmitted from the control unit A1 to the output/input terminal T1 of the cellular phone T via a wire so as to permit the cellular phone to complete the input of the phone number and transmission of the same.

6. Step 2 is repeated.

In such a manner, the extension device of the present invention applied to various types of hand free devices and cellular phones can effectively extend the dialing operation via a service button, making speedy connection to service centers or to specific phone numbers becomes possible.

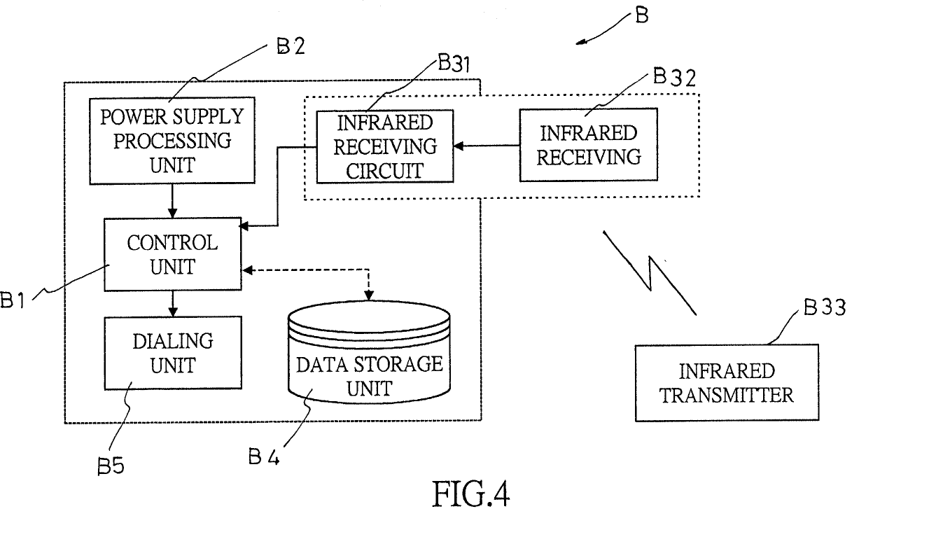

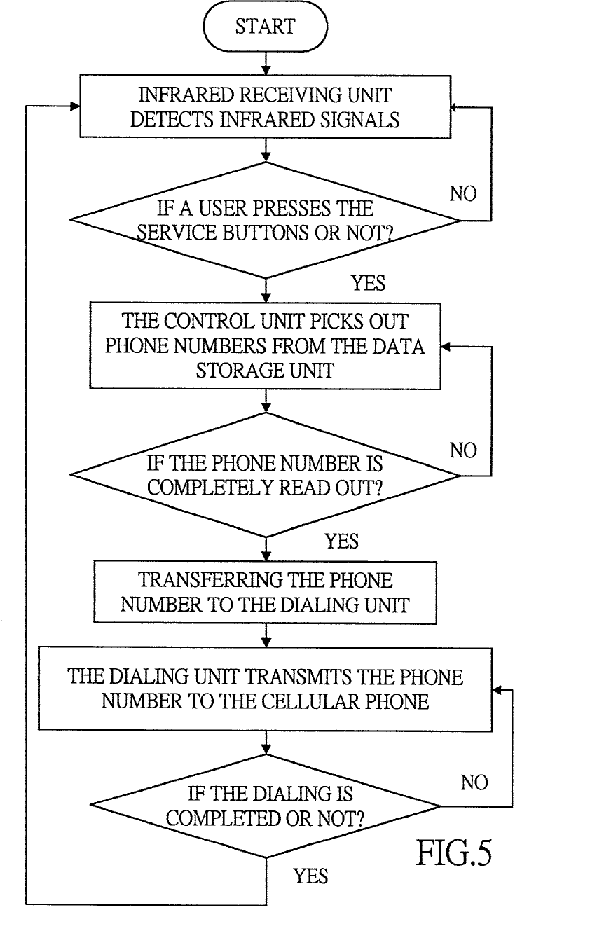

Moreover, as shown in FIGS. 4, 5, the second embodiment of the present invention is illustrated by way of its systematic block diagram and flow chart. Although the present invention can employ a service button to complete the activation of the connection to service centers, the setting of the service button unavoidably spoils the panel of a vehicle. In addition, no suitable location is available for the setting. Therefore, an infrared transmitter B33 in combination with an infrared receiving unit B3 added to the extension device B can be used in place of the operation of the service button in the first embodiment. The extension device B comprises:

a control unit B1 is mainly used to control the operations of individual units of the extension device B and is internally equipped with a control program;

a power supply processing unit B2 coupled to a power circuit of the hand free device H is used to supply electrical power to the extension device B;

an infrared receiving unit B3 including an infrared receiving circuit B31 and an infrared receiver B32; the infrared receiving circuit B31 is used to control the associated components of this unit and process the infrared signals received by the infrared receiver B32 and transmitted to the control unit B1 after decoding;

an infrared transmitter B33 is portable in size with a matrix of press buttons, an infrared coding unit and an infrared transmitting unit disposed thereon;

a data storage unit B4 is a temporary memory unit for storage of phone numbers to be dialed;

a dialing unit B5 can be a DTMF or other dialing circuits for coding the phone numbers transmitted from the control unit B1 and transmitting the same to the cellular phone T for automatic dialing purpose;

By way of the assembly of the above components, a user only has to connect the extension device of the present invention to the hand free device H and the cellular phone T and takes the following steps to connect to a service center or a specific phone in speedy dialing operation.

1. After the extension device B is in connection to the cellular phone T, the hand free device H, the extension device B is set in a standby mode.

2.The infrared receiving unit B3 of the extension device B checks if a user presses the service button B32 of the infrared transmitter B33.

3.After the service button B32 of the infrared transmitter B33 is pressed by a user, the control unit B1 picks out one of preset phone numbers from the data storage unit B4. The numbers can be preset in production or is set in advance by a user.

4.Check if the phone number has been read out, if not, step 3 is repeated; if completed, the control unit B1 will transmit the phone number to the dialing unit B5 and a dialing signal is sent via an output wire to the output/input terminal T1 of the cellular phone, rendering the cellular phone T in a to-be-dialed status in which a phone number is to be input.

5.The dialing unit B5 will control to deliver the phone number transmitted from the control unit B1 to the output/input terminal T1 of the cellular phone T via a wire so as to permit the cellular phone to complete the input of the phone number and transmission of the same.

6. Step 2 is repeated.

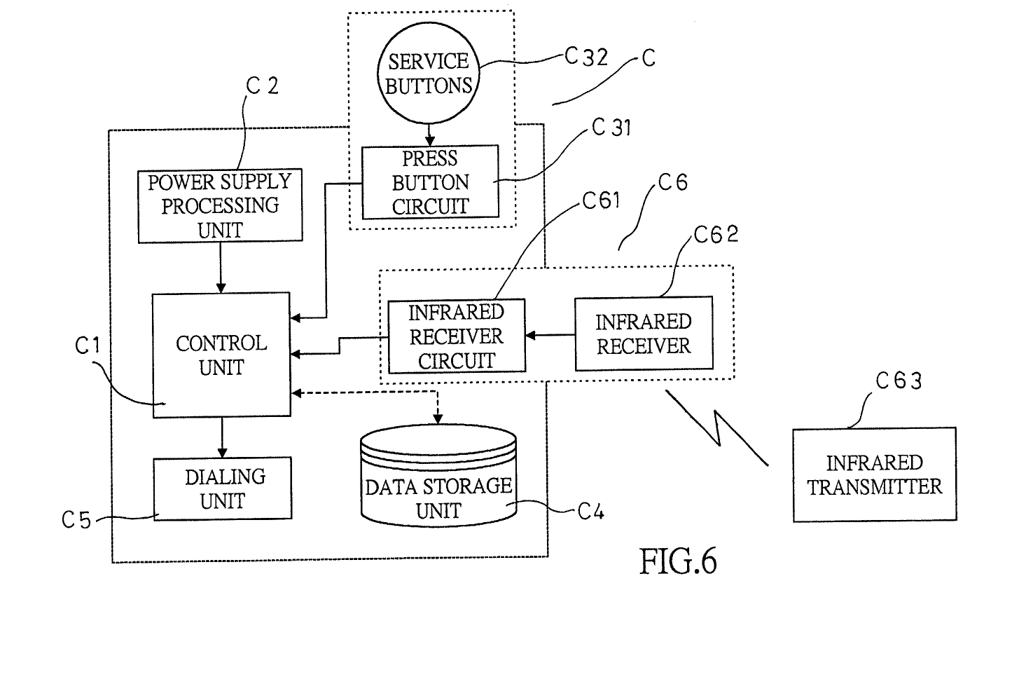

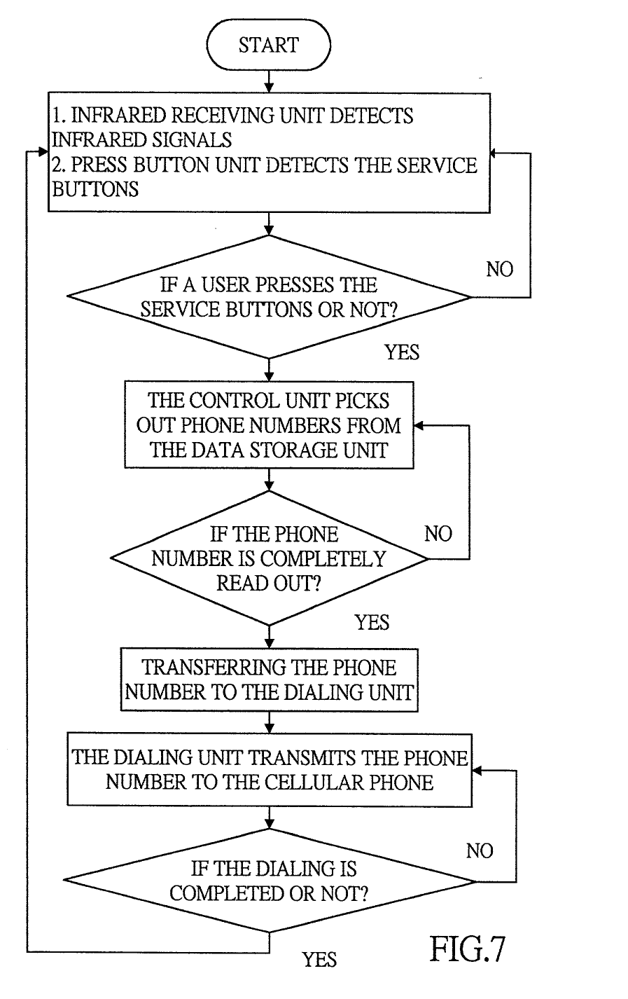

At last, referring to FIGS. 6, 7, the third embodiment of the present invention is illustrated of its systematic block diagram and its operation flow chart. In this embodiment, a remote control method is not the only choice in operation, so, even a remote controller is lost or can not be located for the time being, the extension device is still available without influence. In this instance, the press button unit of the first embodiment is combined with the infrared receiving unit of the second embodiment so that pressing the service button or remote controlling by the infrared transmitter are applicable to effect the dialing operation to connect to service centers.

The third embodiment is equipped with an extension device C having one end coupled to the cellular phone T and another end connected to the hand free device H; wherein the extension device C includes:

a control unit C1 is mainly used to control the operations of individual units of the extension device C and is internally equipped with a control program;

a power supply processing unit C2 coupled to the power circuit of the hand free device H is used to supply electrical power to the extension device C;

a press button unit C3 includes a press button circuit C31 and at least a service button C32;

a data storage unit C4 is a temporary memory unit for storage of the phone numbers to be dialed;

a dialing unit C5 can be a DTMF or other dialing circuits for receiving and coding the phone numbers transmitted from the control unit C1 and delivering further to the cellular phone T for effecting automatic dialing purpose;

an infrared receiving unit C6 including an infrared receiving circuit C61 and an infrared receiver C62; the infrared receiving circuit C61 is used to control the associated components of this unit and process the infrared signals received by the infrared receiver C62 and transmitted to the control unit C1 after decoding;

an infrared transmitter C63 is portable in size with a matrix of pressing buttons, an infrared coding unit and an infrared transmitting unit disposed thereon.

By way of the above components in assembly, a user only has to connect the extension device C to the hand-free device H and the cellular phone T, and follows the following procedures, operating either on the service button C32 or the infrared transmitter C63 for remote control, whereby speedy dialing for connection to a service center or a specific phone can be effected.

1. After the extension device C is in connection to the cellular phone T, the hand free device H, the extension device C is set in a standby mode.

2.The press button unit C3 and the infrared receiving unit C6 of the extension device C checks if a user presses the service button.

3.After the service button is pressed by a user, the control unit C1 picks out one of preset phone numbers from the data storage unit C4. The numbers can be preset in production or is set in advance by a user.

4.Check if the phone number has been read out, if not, step 3 is repeated; if completed, the control unit C1 will transmit the phone number to the dialing unit C5 and a dialing signal is sent via an output wire to the output/input terminal T1 of the cellular phone, rendering the cellular phone T in a to-be-dialed status in which a phone number is ready to be input.

5.The dialing unit C5 will control to deliver the phone number transmitted from the control unit C1 to the output/input terminal T1 of the cellular phone T via a wire so as to permit the cellular phone to complete the input of the phone number and transmission of the same.

6. Step 2 is repeated.

It will of course be understood by those skilled in the art that the particular embodiments of the invention here presented are by way of illustration only, and are meant to be in no way restrictive; therefore, numerous changes and modifications may be made, and the full use of equivalents resorted to, without departing from the spirit or scope of the invention as outlined in the appended claims.

I claim:

1. An extension device for speedy connection of a various kinds of hand free devices for cellular phones to service centers having one end coupled to a cellular phone and another end coupled to a hand free device wherein said extension device comprises:
a control unit is mainly used to control operations of individual units of said extension device and is internally equipped with a control program;
a power supply processing unit coupled to a power circuit of said hand free device is used to supply electrical power to said extension device;
a press button includes a press button circuit and at least a service button or a plurality of press buttons that are marked with a functional indication of service provided by said buttons respectively; each one of said multiple buttons corresponds to a phone number stored in said data storage unit;
a data storage unit is a temporary memory unit for storage of phone numbers to be dialed;
a dialing unit can be a DTMF or other dialing circuits for receiving and coding phone numbers transmitted from said control unit and delivering further said the cellular phone T for effecting automatic dialing.

2. The extension device for speedy connection of various kinds of hand free devices for cellular phones to service centers as claimed in claim 1 wherein an infrared receiving unit is disposed in said extension device to cooperate with an infrared transmitter for replacement of said service button for effecting control of dialing connection;
said infrared receiving unit includes an infrared receiving circuit and a receiver;
said infrared receiving circuit controls associated units of said infrared receiving unit and processing infrared signals received by said infrared receiver by decoding and transmitting to said control unit;
said infrared transmitter is a portable unit having a matrix of press buttons, an infrared coding unit and infrared transmitting unit.

3. The extension device for speedy connection of various hand free devices for cellular phones to service centers as claimed in claim 2 wherein said extension device can also be equipped with a press button unit whereby either said service button or said infrared transmitter can be selectively actuated to effect control of connection operation.
